(19) United States
(12) Patent Application Publication
(10) Pub. No.: US 2011/0130921 A1
(43) Pub. Date: Jun. 2, 2011

(54) IN-VEHICLE DISPLAY SYSTEM

(75) Inventors: Takatsugu ONO, Kobe-shi (JP); Noriyuki KAMIKAWA, Kobe-shi (JP); Tatsuki KUBO, Kobe-shi (JP)

(73) Assignee: FUJITSU TEN LIMITED, KOBE-SHI (JP)

(21) Appl. No.: 12/949,295

(22) Filed: Nov. 18, 2010

(30) Foreign Application Priority Data
Nov. 27, 2009 (JP) 2009-269808

(51) Int. Cl. G06F 19/00; G06F 3/048

(52) U.S. Cl. 701/36; 701/1; 715/771

(57) ABSTRACT

An in-vehicle display system for installation in a vehicle displays information. The in-vehicle display system includes a display part that (i) displays multiple items of setting information respectively related to plural types of in-vehicle apparatus on a common area of a screen interchangeably such that the multiple items of one of the plural types of in-vehicle apparatus are displayed in the common area at one time, and (ii) displays an index indicating one of the in-vehicle apparatus that is presently a displaying subject of the common area, a first switching member, provided separate from the display part, receiving an instruction from a user for switching the in-vehicle apparatus that is the displaying subject to a first apparatus of the plural types of in-vehicle apparatus, and a second switching member, provided separate from the display part, receiving an instruction from the user for switching the in-vehicle apparatus that is the displaying subject to a second apparatus of the plural types of in-vehicle apparatus, the second apparatus being different from the first apparatus, and a position of the second switching member relative to a position of the first switching member corresponds with a displayed position of an index of the second apparatus relative to a displayed position of an index of the first apparatus.

### BACKGROUND OF THE INVENTION

1. Field of the Invention

The invention relates to an in-vehicle display system that displays information to users.

2. Description of the Background Art

Conventionally, there are in-vehicle display systems that are installed in a vehicle such as a car and that display setting information of an in-vehicle apparatus for users (typically drivers.) For example, an in-vehicle display system which displays setting information of an air conditioner (target temperature, wind direction and the like), as well as setting information of audio (sound volume, sources and the like.), is well known.

Generally, a display and a control member of the foregoing in-vehicle display system are required to be placed on limited areas like the center of the dashboard and a center console on a vehicle. Due to such space limitation, when plural types of in-vehicle display systems are positioned to display setting information of each kind of in-vehicle apparatus (for example, when both in-vehicle display systems to display the setting information of an air conditioner and of audio are positioned), there are some cases where respective displays and control members can not be placed at positions where their visibility and operability are satisfactorily achieved. In addition, it is not preferred in terms of cost to provide in-vehicle display systems corresponding to every type of in-vehicle apparatus.

As a countermeasure, it is considered that one in-vehicle display system is used to display the setting information of plural types of in-vehicle apparatus (for example, the setting information of the air conditioner and of the audio.) However, such an in-vehicle display system has difficulty in displaying setting information of all the plural types of in-vehicle apparatus at the same time, due to the limitation of the screen area, or the like. Accordingly, the setting information being displayed should be changed for each of the in-vehicle apparatus. Accordingly, it is necessary for users to select any of the in-vehicle apparatus by a switching operation.

In the in-vehicle display system like this, in many cases, users operate the in-vehicle display system while paying attention to the situation of the outside of the vehicle. Therefore it is preferred that users can intuitively change the in-vehicle apparatus for displaying without looking at the control member and the like directly.

### SUMMARY OF THE INVENTION

According to one aspect of the invention, an in-vehicle display system for installation in a vehicle for displaying information includes: a display part that (i) displays multiple items of setting information respectively related to plural types of in-vehicle apparatus on a common area of a screen interchangeably such that the multiple items of one of the plural types of in-vehicle apparatus are displayed in the common area at one time, and (ii) displays an index indicating one of the in-vehicle apparatus that is presently a displaying subject of the common area; a first switching member, provided separate from the display part, receiving an instruction from a user for switching the in-vehicle apparatus that is the displaying subject to a first apparatus of the plural types of in-vehicle apparatus; and a second switching member, provided separate from the display part, receiving an instruction from the user for switching the in-vehicle apparatus that is the displaying subject to a second apparatus of the plural types of in-vehicle apparatus, the second apparatus being different from the first apparatus. The position of the second switching member relative to a position of the first switching member corresponds with a displayed position of an index of the second apparatus from a displayed position of an index of the first apparatus.

If the user memorizes associating a type of in-vehicle apparatus with its position, the user can change the in-vehicle apparatus to be displayed to another apparatus intuitively without looking directly at the operating part.

According to another aspect of the invention, the in-vehicle display system further includes a setting change member, provided separate from the display part, receiving an instruction from the user for changing a setting related to the in-vehicle apparatus that is the displaying subject. The position of the first switching member relative to a position of the setting change member corresponds with the displayed position of the index of the first apparatus relative to a center of the common area of the screen, and the position of the second switching member relative to the position of the setting change member corresponds with the displayed position of the index of the second apparatus relative to the center of the common area of the screen.

The user can acknowledge the positions of the first switching member and the second switching member readily based on the positions of the setting change member, and therefore perform an operation to change the in-vehicle apparatus to be displayed to another apparatus intuitively.

According to another aspect of the invention, the in-vehicle display system for installation in a vehicle for displaying information includes: a display part that (i) displays multiple items of setting information respectively related to plural types of in-vehicle apparatus on a common area of a screen interchangeably such that the multiple items of one of the plural types of in-vehicle apparatus are displayed in the common area at one time, and (ii) displays an index indicating one of the in-vehicle apparatus that is presently a displaying subject of the common area; a setting change member, provided separate from the display part, receiving an instruction from a user for changing a setting related to the in-vehicle apparatus that is the displaying subject; a designating part designating one item among the multiple items of the setting information as a subject item of setting change that is to be made by the setting change member; and a receiver that receives an instruction from the user for changing the subject item. The designating part automatically designates a predetermined item that is chosen for each of the plural types of in-vehicle apparatus as the subject item when the user does not input any instruction after a predetermined period of time.

By designating an item of the setting that is changed frequently as the predetermined item, the setting that is frequently changed can be changed easily. As the result, the user can perform an operation of the setting change intuitively.

Therefore, the purpose of the invention is to provide the in-vehicle display system that the user can change the in-vehicle apparatus to be displayed intuitively without looking directly at an operating member.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a block diagram of a structure of an in-vehicle display system;

FIG. 2 shows exemplary positions of a display and a controller;

FIG. 3 shows an exemplary appearance of a controller;

FIG. 4 shows an example of a screen on the display;

FIG. 5 shows an example of display on the display in an air conditioner mode;

FIG. 6 shows an example of display on the display in an audio mode;

FIG. 7 shows a drawing to explain a switch of an operating mode of an in-vehicle display system;

FIG. 8 is a drawing to show a screen on the display when the setting of an air conditioner apparatus is changed;

FIG. 9 is a drawing to show a screen on the display when the setting of an audio apparatus is changed;

FIG. 10 is a drawing to show a screen on the display when sources are changed;

FIG. 11 shows an example of display on the display in an air conditioner mode;

FIG. 12 shows an example of display on the display in an audio mode;

FIG. 13 is a drawing to show a screen on the display when the setting of the air conditioner apparatus is changed;

FIG. 14 is a drawing to show a screen of the display when sources are changed;

FIG. 15 is a drawing to show the status where a controller is provided in a steering wheel;

FIG. 16 shows an exemplary appearance of the controller; and

FIG. 17 shows another exemplary appearance of the controller.

### DESCRIPTION OF THE EMBODIMENTS

Herein below, embodiments of the invention are described with reference to drawings.

### 1. First Embodiment

### 1-1. Composition

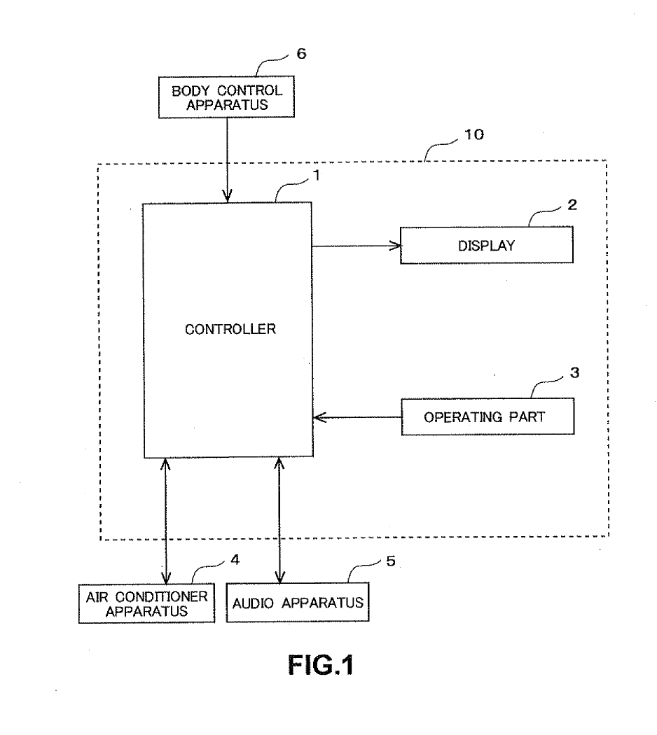

FIG. 1 is a block diagram that shows a structure of an in-vehicle display system 10 of the embodiment along with a peripheral structure. This in-vehicle display system 10, which is installed in a vehicle (a car in this embodiment), displays information to users like drivers in a vehicle. The in-vehicle display system 10 displays setting information related to plural in-vehicle apparatus installed in vehicle, and also accepts a setting change from a user.

The in-vehicle display system 10 includes a controller 1 that controls the overall apparatus, a display 2 that displays information, and an operating part 3 that receives user's operations. The display 2 and the operating part 3 are connected with the controller 1 electrically. Therefore, the display 2 is operated under the control of the controller 1 while user's operation to control the operating part 3 is entered into the controller 1 as a signal.

The controller 1 is configured as ECU (Electronic Control Unit) for example, and placed at a predetermined and hidden position on an inner surface of a vehicle cabin. The controller 1 includes a computer including CPU, RAM and ROM. Control functions of the controller 1 are realized through processing operation performed by CPU according to the program as firmware stored at ROM and the like in advance.

The controller 1 has a function of controlling display on the display 2 and a function of exercising control according to user's instruction via the operating part 3. The display 2 in the embodiment does not include a touch panel function. When a user gives instructions to the in-vehicle display system 10, the user operates the operating part 3 while confirming display on the display 2. The controller 1 recognizes the user' instruction based on the performance of the operating part 3 and then controls the in-vehicle display system 10 so that it operates according to the user's instruction.

Further, the controller 1 connects with plural apparatus installed in a vehicle, specifically with an air conditioner apparatus 4 and an audio apparatus 5 electrically.

The air conditioner apparatus 4 controls the temperature in a vehicle cabin according to the setting of target temperature, wind direction and air volume. The setting information which indicates the setting values of target temperature, wind direction and air volume is entered into the controller 1 from the air conditioner apparatus 4 and then is displayed on the display 2 under the control of the controller 1. In addition, the controller 1 transmits signals to the air conditioner apparatus 4 and then can change the setting of the air conditioner apparatus 4 in accordance with user's instruction via the operating part 3.

The audio apparatus 5 outputs a sound in a vehicle cabin via speakers. As sources of sounds that the audio apparatus 5 can play, broadcasting signals like AM and FM, recording contents of disk media like CD and output signals from external devices like portable music players are available. The audio apparatus 5 outputs the sound according to the setting of a sound volume, of a source and of a sound identifying information (frequency, channel and tracks and the like) that identifies the sound in the sources. The setting information which indicates the setting of the sound volume, the source and the sound identifying information is entered into the controller 1 from the audio apparatus 5 and then is displayed on the display 2 according to the control of the controller 1. Further, the controller 1 transmits signals to the audio apparatus 5 and can change the setting of the audio apparatus 5 according to user's instruction via the operating part 3.

Thus, the display 2 can display the setting information of both the air conditioner apparatus 4 and the audio apparatus 5. However, the display 2 cannot display both of the setting information of these apparatus at the same time. The display 2 displays the setting information of the air conditioner apparatus 4 and the setting information of the audio apparatus 5 alternately.

The in-vehicle display system 10 has two operating modes: an air conditioner mode and an audio mode. In the air conditioner mode, the setting information of the air conditioner apparatus 4 is displayed on the display 2 and the change of setting of the air conditioner apparatus 4 is allowed by the operation on the operating part 3. On the other hand, in the audio mode, the setting information of the audio apparatus 5 is displayed on the display 2 and the operation on the operating part 3 allows the setting of audio apparatus 5 to be changed. These operating modes can be switched easily through the operation on the operating part 3. The details will be described later.

The controller 1 is electrically connected with a body control apparatus 6 related to the running of a vehicle. Running information like a cumulative running distance, a remaining amount of gasoline and eco-driving, and shift position status are entered into the controller 1 from the body control apparatus 6. Such the running information and the shift position status are displayed on the display 2 under the control of the controller 1.

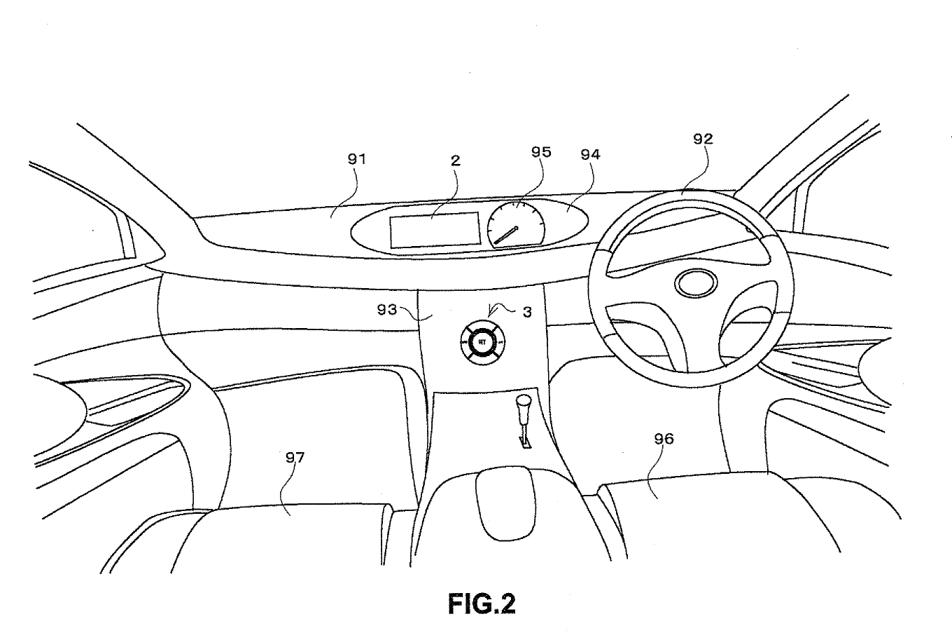

The display 2 and the operating part 3, independent from the controller 1, are positioned at suitable positions respectively within a vehicle cabin. FIG. 2 shows exemplary positions of the display 2 and the operating part 3 within a vehicle cabin.

As illustrated, the display 2 is positioned within a meter panel 94 at a center between opposite sides of a dashboard 91, with a speed meter 95 and the like. Such a position helps to reduce a moving distance of the line of sight of the driver when looking at the display 2. The operating part 3 is installed separately from the display 2 and is positioned roughly in the center of a center console 93. The vehicle in this embodiment is a right-hand drive car. Therefore, the driver sitting on a driver seat 96 can operate the operating part 3 only with a left hand if necessary, while holding a steering wheel 92 with a right hand. A user sitting on a passenger seat 97 can operate the operating part 3 if necessary.

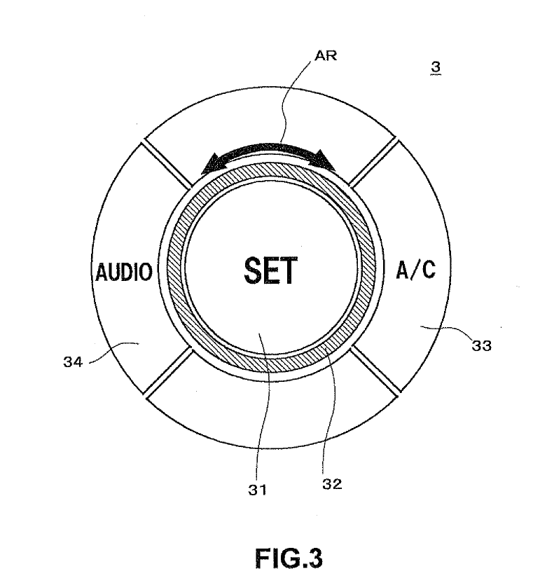

FIG. 3 shows an appearance of the operating part 3. As illustrated, the operating part 3 includes a set button 31, a rotating dial 32, an air conditioner button 33 and an audio button 34. The set button 31 having a cylinder shape is formed so that its circular surface can be pressed. The rotating dial 32 is located along outer circumference of the set button 31, and is formed to be rotatable both clockwise and counterclockwise surrounding the set button 31, as shown by an arrow AR in FIG. 3.

The set button 31 and the rotating dial 32 function as members that receive user's instruction to change the setting related to the in-vehicle apparatus. In other words, when the setting of the air conditioner apparatus 4 or the audio apparatus 5 is changed, a user can select any contents to be set by rotating the rotating dial 32 and can determine the contents of the selection by pressing the set button 31.

The air conditioner button 33, formed to be pressable, is a button which can switch the operating mode to the air conditioner mode. In other words, the air conditioner button 33 is a button that receives user's instruction for switching the in-vehicle apparatus of the displaying subject to the air conditioner apparatus 4. On the other hand, the audio button 34, formed to be pressable, is a button to switch the operating mode to the audio mode. In other words, the audio button 34 is a button that receives user's instruction for switching the in-vehicle apparatus of the displaying subject to the audio apparatus 5.

The air conditioner button 33 is located adjacent to the set button 31 and the rotating dial 32 on the right side thereof (in the right position relative to the position of the set button 31 and the rotating dial 32). On the other hand, the audio button 34 is located adjacent to the set button 31 and the rotating dial 32 on the left side thereof (in the left position relative to the position of the set button 31 and the rotating dial 32).

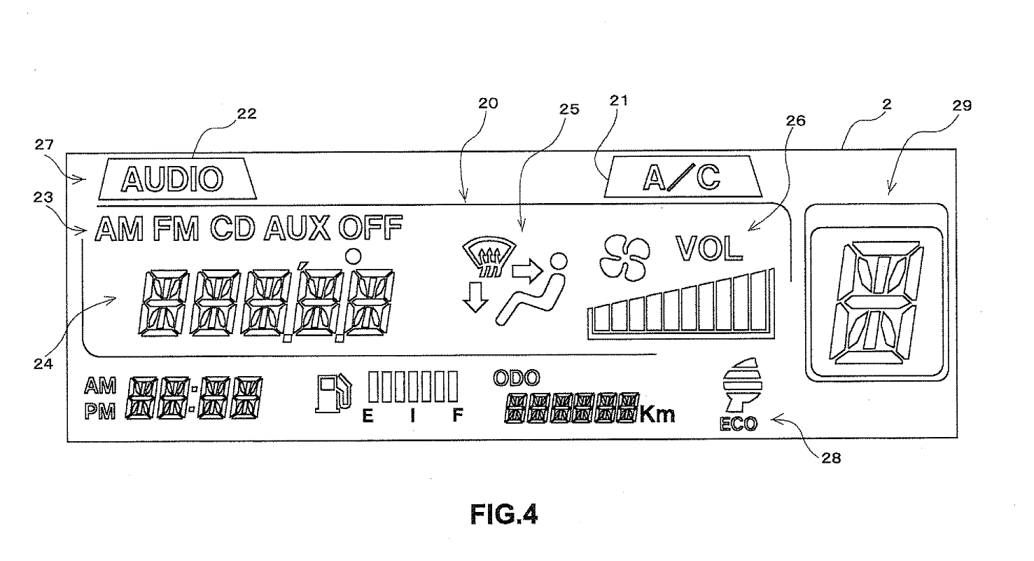

FIG. 4 shows an exemplary screen of the display 2. The display 2 has a segment liquid crystal display, indicating information by switching plural segments between an active state and an inactive state.

The upper part of the screen of the display 2 has an index area 27 that displays the index of the operating mode which is presently established. The lower part of the screen of the display 2 has a running information area 28 that displays the running information. The right side of the screen of the display 2 has a shift position area 29 that displays the shift position status. A major area, excluding the areas 27, 28 and 29 of the screen of the display 2, is a common area 20, which displays the setting information of the air conditioner apparatus 4 and the setting information of the audio apparatus 5 alternately.

The common area 20 has a character area 24 displaying numbers and alphabets on the left side, a wind direction area 25 displaying the wind direction of the air conditioner apparatus 4 on roughly a center, and a graph area 26 displaying a volume of air by a bar graph on the right side. The upper part of the character area 24 has a source area 23 that displays the source of sounds that are played on the audio apparatus 5.

In the index area 27, either an air conditioner index 21 indicating an air conditioner mode M1 or an audio index 22 indicating an audio mode M2 is indicated like a tab. By displaying either of the indexes 21 and 22, it is clearly shown that either in-vehicle apparatus of the air conditioner apparatus 4 and the audio apparatus 5 is presently the displaying subject. The displayed position of the air conditioner index 21 is on the right side of a center between opposite sides of the common area 20 (in the right position relative to the center). On the other hand, the displayed position of the audio index 22 is on the left side of the center between opposite sides of the common area 20 (in the left position relative to the center).

### 1-2. Switch of the Operating Modes

Next, switch of the operating modes is described. The in-vehicle display system 10 has two operating modes: the air conditioner mode and the audio mode as described above.

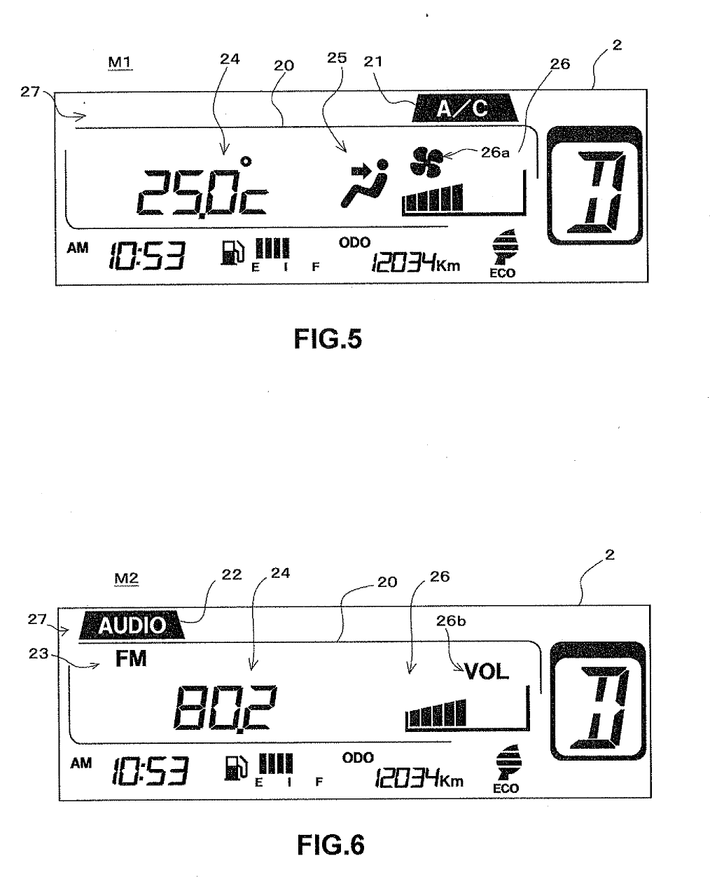

FIG. 5 shows an exemplary display on the display 2 in the air conditioner mode M1. In the mode M1, the setting information of the air conditioner apparatus 4 is displayed in the common area 20 on the display 2 as illustrated. Concretely, the target temperature is displayed in the character area 24, the wind direction is in the wind direction area 25 and the air volume is in the graph area 26. That the volume shown in the graph area 26 is the air volume is indicated by an icon 26a in the vicinity. Further, the air conditioner index 21 that shows the air conditioner mode is also indicated on the right side of the center between opposite sides of the common area 20 (in the right position relative to the center).

FIG. 6 shows an exemplary display on the display 2 in the audio mode M2. As illustrated, in the mode M2, the setting information of the audio apparatus 5 is displayed in the common area 20 on the display 2. Concretely, the source is displayed in the source area 23 (FM, in FIG. 6), the sound identifying information is displayed in the character area 24 (FM frequency, in FIG. 6), and the sound volume is displayed in the graph area 26. That the volume shown in the graph area 26 is the sound volume is indicated by an icon 26b in the vicinity. The audio index 22 that shows the audio mode is also displayed on the left side of the center between opposite sides of the common area 20 (in the left position relative to the center).

Thus, the display 2 displays the setting information of the air conditioner apparatus 4 and the setting information of the audio apparatus 5 respectively in the common area 20 alternately, with selection of the air conditioner apparatus 4 or the audio apparatus 5 for display by a switching operation. In this case, two of the indexes 21 and 22 indicate that the in-vehicle apparatus that is presently the displaying subject is the air conditioner apparatus 4 or the audio apparatus 5.

This relative position between the air conditioner index 21 and the audio index 22 corresponds to the relative position between the air conditioner button 33 and the audio button 34. This helps a user to change the operating mode intuitively in the in-vehicle display system 10.

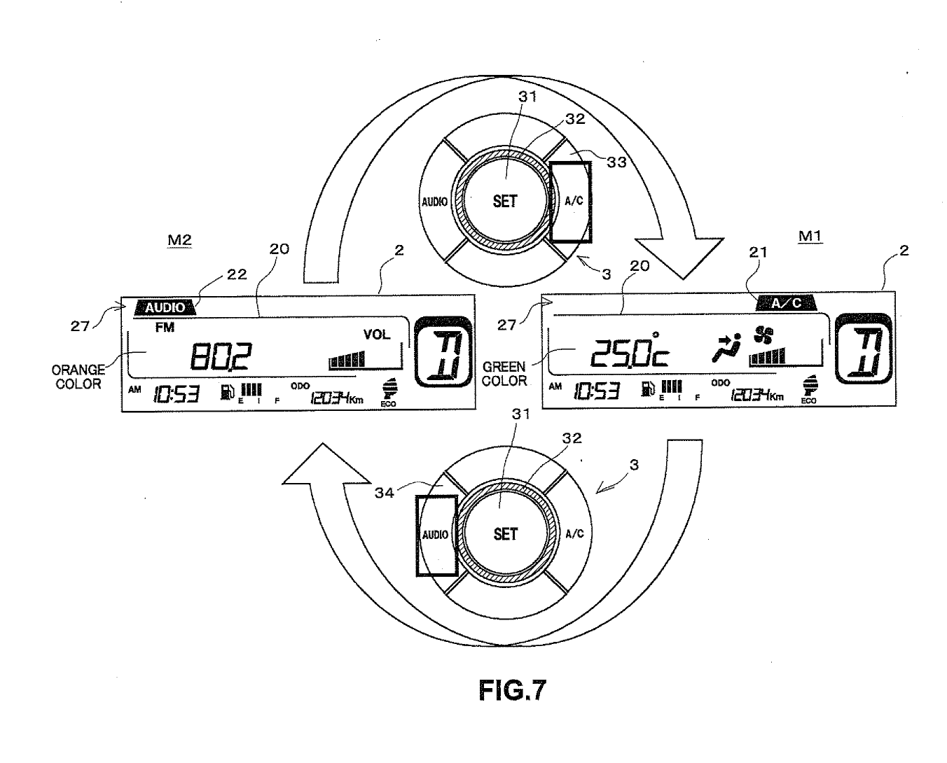

FIG. 7 describes the switching of the operating mode in the in-vehicle display system 10. When the in-vehicle display system 10 starts, it starts with the operating mode that is the mode when the power was turned off last time, out of the air conditioner mode M1 and the audio mode M2 (so-called “last mode”.)

As illustrated, when the operating mode is the audio mode M2, pressing the air conditioner button 33 switches the operating mode to the air conditioner mode M1. In this case, the position of the air conditioner button 33 relative to the position of the set button 31 and the rotating dial 32 is the right, and the displaying position of the air conditioner index 21 relative to the center between opposite sides of the common area 20 is correspondingly the right. In other words, the air conditioner button 33 and the air conditioner index 21, which relate to the air conditioner mode M1, are both positioned on the right side.

On the other hand, when the operating mode is the air conditioner mode M1, pressing the audio button 34 switches the operating mode to the audio mode M2. In this case, the position of the audio button 34 relative to the set button 31 and the rotating dial 32 is the left, and the displaying position of the audio index 22 relative to the center between opposite sides of the common area 20 is correspondingly the left. In other words, the audio button 34 and the audio index 22, which relate to the audio mode M2, are both positioned on the left side.

In other words, the position of the audio button 34 relative to the position of the air conditioner button 33 is the left. The position of the audio index 22 relative to the position of the air conditioner index 21 is also the left. These positions are the same.

Accordingly, when a user memorizes associating the air conditioner mode M1 with the right side and associating the audio mode M2 with the left side, the user can change the operating mode to the desired one without looking at the description on the operating part 3 directly. The user also can recognize which mode is selected by the displayed index position without confirming the description on the index. When the user presses the right button on the operating part 3, the index on the display 2 moves to the right side. When pressing the left button on the operating part 3, the index on the display 2 moves to the left side. These operations help the user change the in-vehicle apparatus of the displaying subject intuitively.

The setting change of the air conditioner apparatus 4 is mainly operated by a driver, while, in many cases, the setting change of the audio apparatus 5 is conducted not only by the driver but by the user on the passenger seat 97. Therefore, in the in-vehicle display system 10 of the embodiment, the air conditioner button 33 to switch the present mode to the air conditioner mode M1 is on the drivers' side (right side) and the audio button 34 to switch the present mode to the audio mode M2 is located on the passenger side (left side) respectively. This location helps both the driver and the user on the passenger seat 97 to handle the buttons more easily. The vehicle of the embodiment has the steering wheel on the right. However, in the vehicle which is a left-hand drive car, it is desirable that the air conditioner button 33 and the air conditioner index 21 related to the air conditioner mode M1 are located on the left, and the audio button 34 and the audio index 22 related to the audio, mode are located on the right.

In the display 2, it is desirable to differentiate a background color of the screen including the common area 20 between the air conditioner mode M1 and the audio mode M2. For example, it is possible that the background color is set green in the air conditioner mode M1 and orange in the audio mode M2. This can be readily implemented when the display 2 is equipped with two back lights with different colored light sources and one of the back lights is selected to light up. according to the operating mode. Thus, if the background color of the screen is different according to the operating mode, a user can recognize which operating mode is activated (which in-vehicle apparatus is the displaying subject) intuitively.

### 1-3. Setting Change

Next, changes of the setting in operating modes are described. As described above, the change in the setting of the in-vehicle apparatus can be operated by the set button 31 and by the rotating dial 32. When the setting change is operated, a subject item that is presently a subject of the setting change is designated by the controller 1.

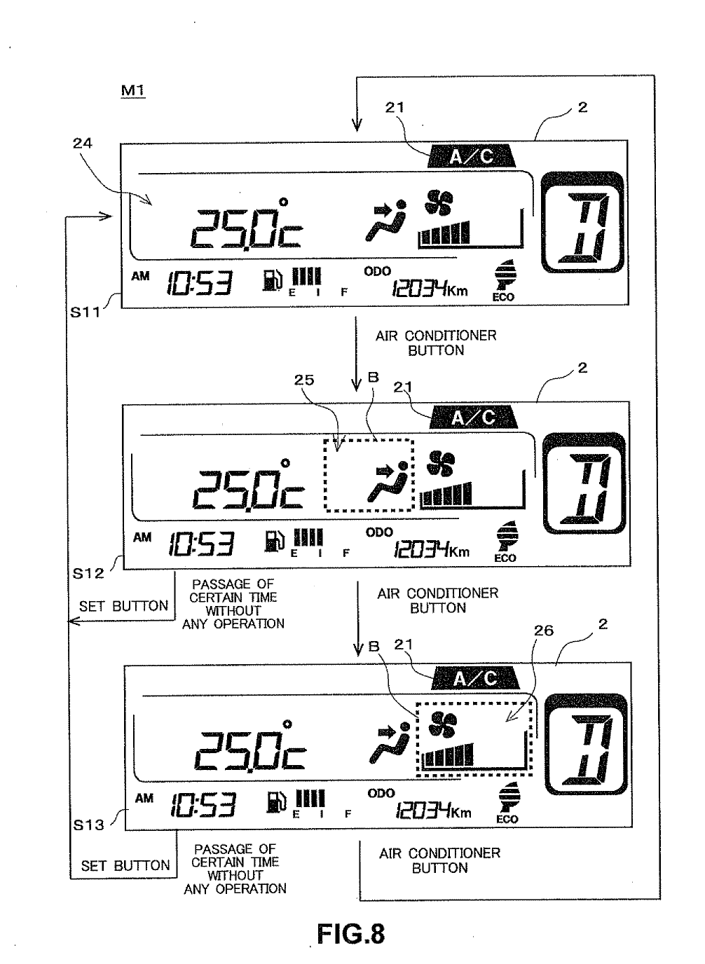

FIG. 8 illustrates the screen of the display 2 when the setting of the air conditioner apparatus 4 is changed, in the air conditioner mode M1. A state S11 is the default state just after the operating mode is changed to the air conditioner mode M1. Every time the air conditioner button 33 is pressed, the state of the screen of the display 2 changes from the default state S11 to the state S12 and then a state S13. When the air conditioner button 33 is pressed in the state S13, the screen returns to the default state S11. Thus, every time the state of the screen of the display 2 is switched, the subject item that is the subject of the setting change is changed. Accordingly, the air conditioner button 33 becomes the operating member that receives user's instruction for changing the subject item.

In the default state S11, the target temperature displayed in the character area 24 is specified as the subject item. In this case, the target temperature can be changed by the operation of the rotating dial 32 and the target temperature can be determined by pressing the set button 31. Generally, the target temperature is most frequently changed among the setting (the target temperature, the wind direction and the air volume) of the air conditioner apparatus 4. In the default state S11, the target temperature is specified as the subject item, so that the target temperature can be changed at a desirable timing just after the operating mode is switched to the air conditioner mode M1. As a result, the target temperature that is changed frequently can be changed with fewer operations. Hereinafter, changeable items (in this case, the target temperature) in the default state S11 are referred to as a “default item”.

In the state S12, the wind direction displayed in the wind direction area 25 is specified as the subject item. In this case, the blinking of the display in the wind direction area 25 demonstrates to a user that the wind direction is the subject item. A framework B drawn in the figure by broken line shows that the area surrounded by the framework B is blinking (Same for the following figures). In this case, the operation of the rotating dial 32 can change the wind direction and the pressing of the set button 31 can determine the wind direction.

In the state S13, the air volume displayed in the graph area 26 is specified as the subject item. In this case, the blinking of the display in the graph area 26 demonstrates to a user that the air volume is the subject item. In this case, the operation of the rotating dial 32 can change the air volume and pressing of the set button 31 can determine the air volume.

In the states S12 and S13, when the set button 31 is pressed, the state of the screen of the display 2 moves to the default state S11 after determining the contents of the setting selected by the rotating dial 32. In any states S11, S12 and S13, when the air conditioner button 33 is pressed after selecting the setting contents by the rotating dial 32, the screen moves to the next state after determining the setting contents selected by the rotating dial 32 (For example, if the present state is the state S12, the screen moves to the state S13.) Thus, without pressing the set button 31, a user can change the setting of multiple items with fewer operations. Further, when the air conditioner button 33 is pressed, it may be set to move to the next state without determining the setting contents selected by the rotating dial 32.

In the state S12 or S13, when a user does not operate the operating part 3 for the predetermined period of time (for example, 6 seconds), the state of the screen of the display 2 returns to the default state S11. In many cases, driver changes the setting while making a stop for a relatively short time like a waiting time of traffic signal. This sometimes causes the drivers to start moving vehicles in the middle of the operation and to interrupt the operation related to the setting change. In this case, drivers often tend to forget that the operation of the setting change is interrupted, while driving. If the state S12 or S13 is maintained, there is strong possibility that drivers make wrong setting in the following operations. Therefore, in this case, the screen returns to the default state S11 and the default item is automatically specified as the subject item, so that drivers can avoid making a wrong setting and can immediately change the default item which is changed frequently. As a result, the operation related to the setting change can be conducted intuitively. Further, in this case, if details of the setting selected by the rotating dial 32 are determined when the screen moves to the default state of S11, a user can change multiple items with fewer operations without pressing the set button 31 and return to the default state of S11. Further, it is also possible to move to the default state S11 without determining the setting contents selected by the rotating dial 32.

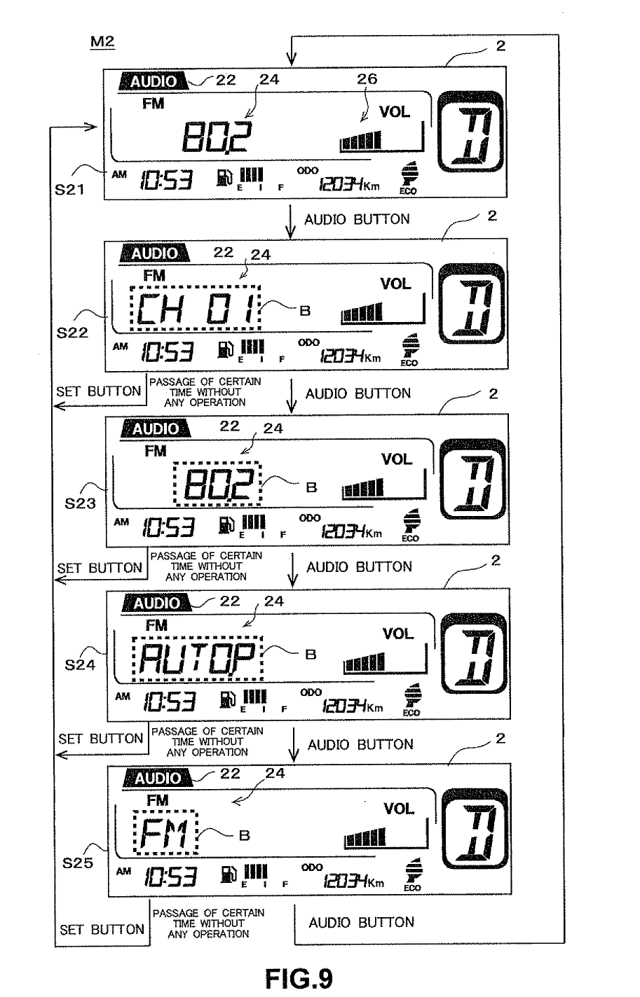

FIG. 9 illustrates the screen of the display 2 when the setting of the audio apparatus 5 is changed, in the audio mode M2. FIG. 9 shows an example when FM is selected as the source.

A state S21 is a default state just after the operating mode is changed to the audio mode M2. Every time the audio button 34 is pressed, the state of the screen of the display 2 moves from the default state S21 to states S22, S23, S24 and S25. When the audio button 34 is pressed in the state S25, the screen returns to the default state of S21. Thus, every time the state of the screen of the display 2 is switched, the subject item that is the subject of the setting change is changed. Therefore, the audio button 34 becomes the operating member to receive user's instruction to change the subject item.

In the default state S21, the sound volume displayed in the graph area 26 is specified as the subject item. In this case, the sound volume can be changed by the operation of the rotating dial 32 and be determined by pressing the set button 31. Generally, the sound volume is most frequently changed among the setting (sound volume, source and specific information on sound) of the audio apparatus 5. In the default state S21, the sound volume is specified as the subject item so that the sound volume can be changed at a desirable timing just after the operating mode is switched to the audio mode M2. As a result, the sound volume that is changed frequently can be changed with fewer operations. Hereinafter, changeable items (in this case, the sound volume) in the default state S21 are referred to as a “default item”.

In the state S22, a channel, one of the sound identifying information, is displayed in the character area 24 and is specified as the subject item. In this case, the blinking of the display in the character area 24 demonstrates to a user that the channel is the subject item. The operation of the rotating dial 32 can change the channel and the pressing of the set button 31 can determine the channel.

In the state S23, a frequency, one of the sound identifying information, is displayed in the character area 24 and the frequency is specified as the subject item. In this case, the blinking of the display in the character area 24, the frequency, demonstrates to a user that the frequency is the subject item. In this case, the operation of the rotating dial 32 can change the frequency and the pressing of the set button 31 can determine the frequency.

In the state S24, “AUTO.P” meaning an automatic preset is displayed in the character area 24. In this case, the display of “AUTO.P” blinks in the character area 24. In this state, when the set button 31 is pressed for a predetermined period of time (for example, 1 second), the automatic preset is performed.

In the state S25, a source is displayed in the character area 24 and is specified as the subject item. In this case, the blinking of the displays indicating the source in the character area 24 demonstrates to a user that the source is the subject item. In this case, the operation of the rotating dial 32 can change the source and the pressing of the set button 31 can determine the source.

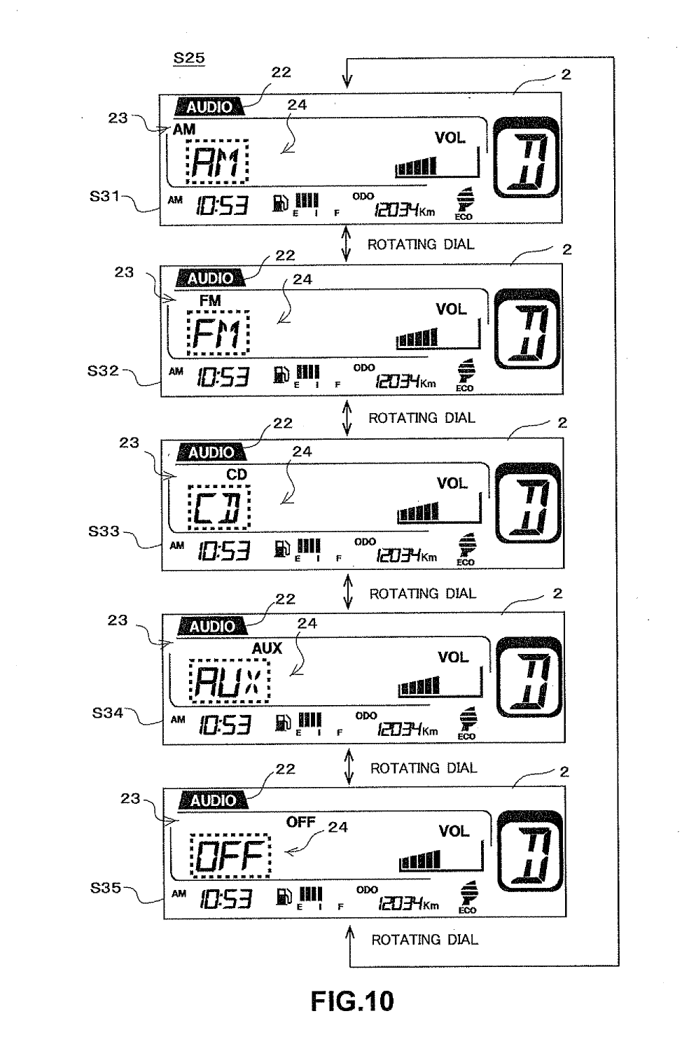

FIG. 10 shows the transition of the screen of the display 2 when the rotating dial 32 is operated in the state S25. With the operation of the rotating dial 32, the source displayed in the source area 23 is changed as illustrated in FIG. 10 from the state S31 to a state S35. The corresponding source is also displayed in the character area 24. This helps a user to easily recognize which source is selected.

Referring back to FIG. 9, in the states S22, S23 and S24, when the set button 31 is pressed, the state of the screen of the display 2 moves to the default state S21 after determining details of the setting selected by the rotating dial 32.

In the states S21, S22, S23 and S24, when the audio button 34 is pressed after selecting the setting contents by the rotating dial 32, the state moves to the next state after determining the setting contents selected by the rotating dial 32. (For example, if the present state is the state S22, the state moves to the next state S23.) Thus, without pressing the set button 31, a user can change the setting of multiple items with fewer operations. Further, when the audio button 34 is pressed, it may be set to move to the next state without determining details of the setting selected by the rotating dial 32.

In the states S22, S23, S24, and S25, when a user does not operate the operating part 3 for the predetermined period of time (for example, 6 seconds), the state of the screen of the display 2 returns to the default state S21. In this case, too, the screen returns to the default state S21 and the default item is automatically identified as the subject item, so that drivers can avoid making a wrong setting and can immediately change the default item which is changed frequently. As a result, the operation related to the setting change can be conducted intuitively. Further, in this case too, moving to the default state of S21 is allowed in both situations where details of the setting that is selected by the rotating dial 32 are determined and not determined.

As described above, when the user does not operate in the in-vehicle display system 10 for the predetermined period of time, the default item is automatically specified as the subject item that is a subject of the setting change. Thus, designating the item that is changed frequently as the default item allows setting that is changed frequently to be immediately changed. As a result, operations related to the changes of the setting can be conducted intuitively.

### 2. Second Embodiment

Next, the second embodiment is described. While in the first embodiment, a segment LCD has been adopted as the display 2, but it is certainly possible to adopt a dot matrix LCD as the display 2. In the second embodiment, instead of the display 2 of the first embodiment, the dot matrix LCD is adopted. Basic structures and operations of the in-vehicle display system in the second embodiment are the same with those in the first embodiment. Therefore, differences between the first and the second embodiment are mainly described as follows.

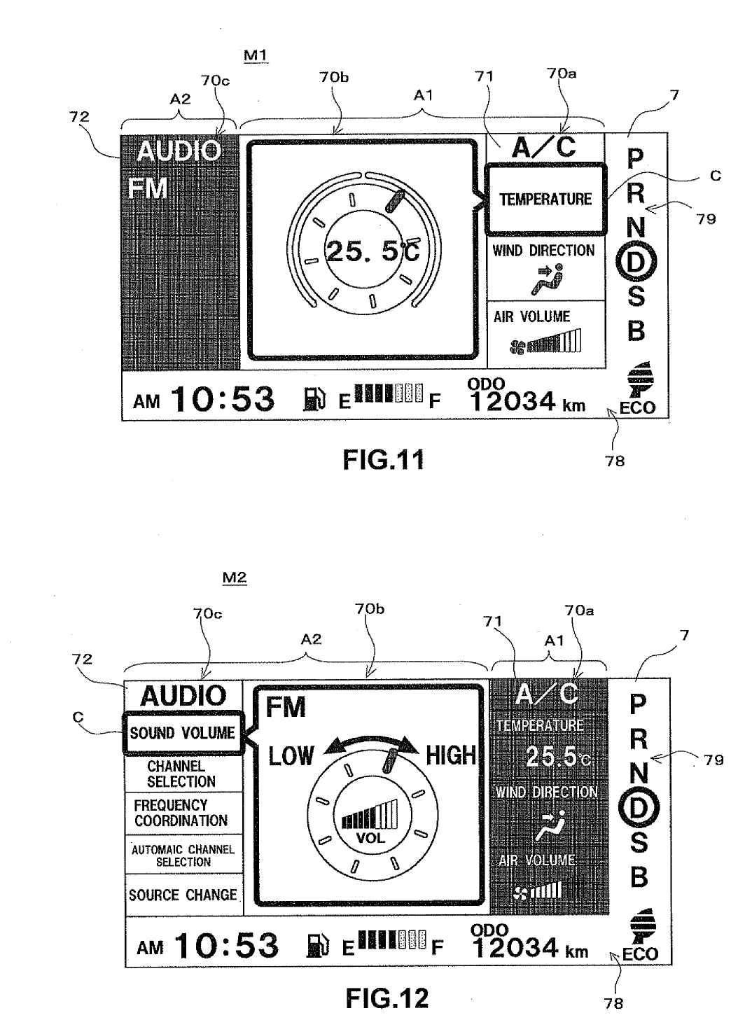

FIG. 11 shows an exemplary display on a display 7 in the air conditioner mode M1. FIG. 12 shows an exemplary display on the display 7 in the audio mode M2. The display 7, for example, includes a dot matrix LCD like TFT.

As illustrated in these figures, a running information area 78, which displays the information on running, is provided in the lower part of the screen of the display 7 and a shift information area 79, which displays the shift position, is provided in the right-hand area in the screen of the display 7. Areas on the screen of the display 7, other than the areas of 78 and 79, are divided into three areas 70a, 70b, and 70c. Among those areas 70a to 70c, an area 70a in the right-hand area displays air conditioner information only related to the air conditioner apparatus 4 and the area 70c in the left-hand area displays audio information only related to the audio apparatus 5. The area 70b, the center among three areas 70a to 70c, is a common area which displays the setting information of the air conditioner apparatus 4 and the setting information of the audio apparatus 5 alternately.

As illustrated in FIG. 11, information related to the air conditioner apparatus 4 is displayed in a relatively broad area A1, combined area of the air conditioner area 70a and the common area 70b, in the air conditioner mode M1. On the other hand, in a relatively smaller area A2 of the audio area 70c alone, information related to the audio apparatus 5 is displayed. In this case, the area A1 including an air conditioner index 71 in the upper part of the air conditioner area 70a provides a light background while the area A2 including an audio index 72 in the upper part of the audio area 70c provides a dark background. With this scheme, it is clearly shown that the air conditioner mode M1 is set.

As illustrated in FIG. 12, information related to the audio apparatus 5 is displayed in the relatively broad area A2, combined area of the audio area 70c and the common area 70b, in the audio mode M2. On the other hand, in the relatively smaller area A1 of the air conditioner area 70a alone, information related to the air conditioner apparatus 4 is displayed. In this case, the area A2 including the audio index 72 in the upper part of the audio area 70c provides a light background while the area of A1 including the air conditioner index 71 in the upper part of the air conditioner area 70a provides a dark background. With this scheme, it is clearly shown that the audio mode M2 is set. In addition, in the audio mode M2, the setting information on the air conditioner apparatus 4 is displayed.

In this embodiment, the displayed position of the air conditioner index 71 relative to the center between opposite sides of the common area 70b is the right, and the displayed position of the audio index 72 relative to the center between opposite sides of the common area 70b is the left. In other words, the displayed position of the audio index 72 relative to the displayed position of the air conditioner index 71 is the left. In this embodiment, the operating part 3 is identical with the one illustrated with FIG. 3. Therefore, in the embodiment, too, if a user memorizes associating a type of in-vehicle apparatus with its position, the user can change the in-vehicle apparatus of the displaying subject intuitively without looking at the operating part 3 directly.

In addition, in this embodiment, the setting of the in-vehicle apparatus can be changed in the same operation with the first embodiment.

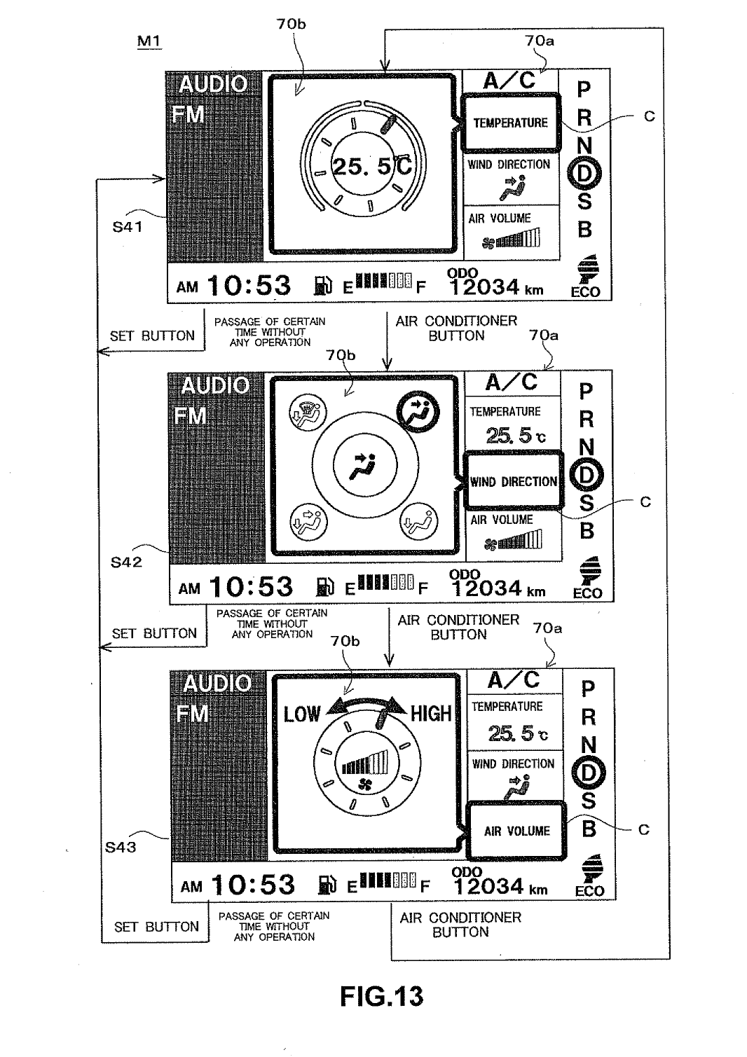

FIG. 13 illustrates a screen of the display 7 when setting of the air conditioner apparatus 4 is changed in the air conditioner mode M1. A state S41 is a state of default just after the operating mode is changed to the air conditioner mode M1. Every time the air conditioner button 33 is pressed in the default state S41, the state of the screen of the display 2 changes to a state S42 and then a state S43. When the air conditioner button 33 is pressed in the state S43, the screen returns to the default state S41.

In the display 7, a subject item that is a subject of the setting change is displayed by a cursor C and concrete contents of the subject item are displayed in the common area 70b. Thus, every time the state of screen of the display 7 is switched, the cursor C moves and the subject item that is a subject of the setting change is changed. Possible operations in the state from S41 to S43 are the same as the operations which are described in the states S11 to S13 in FIG. 8. The setting of the air conditioner apparatus 4 can be changed in the same operations as the first embodiment.

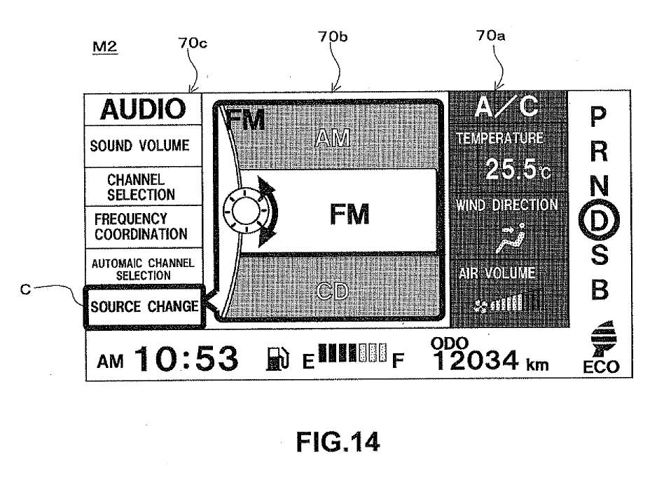

In the audio mode M2, setting in the audio apparatus 5 can be changed by the same operation as the first embodiment. In this case, too, the subject item that is a subject of the setting change is displayed by the cursor C and concrete contents of the subject item are displayed in the common area 70b. For example, FIG. 14 shows an example of the screen of the display 7 in the state where a source is selected as the subject item.

As described above, when the dot matrix LCD is adopted, the same effects are expected as in the first embodiment.

### 3. Alternative Embodiment

Next, an alternative embodiment is described. All the embodiments including the embodiments described in the above and the embodiment described below can be mixed properly.

### 3-1. Controller Layout

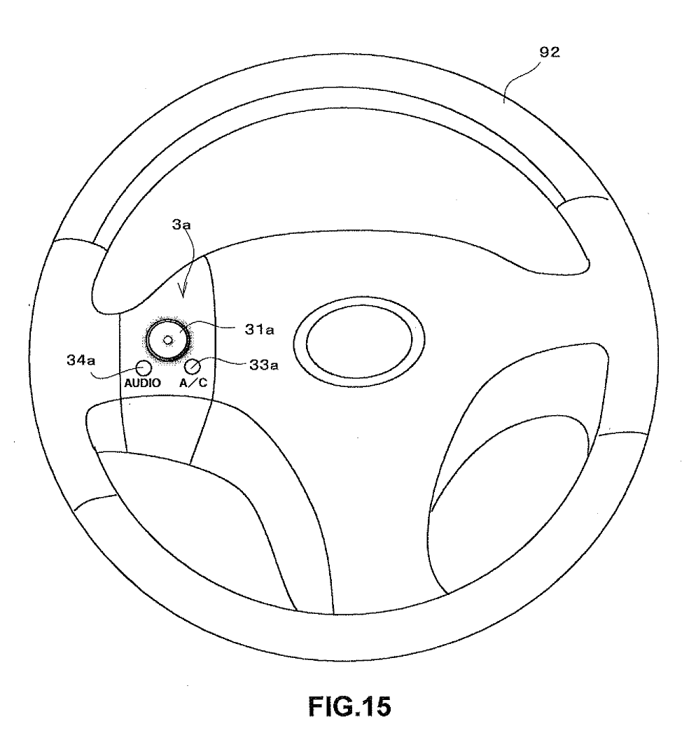

For example, the above embodiments describe that the operating part 3 is provided in the center console 93; however the operating 3 can be located at an arbitrary position where a user can handle readily. For example, as shown in FIG. 15, an operating part 3a can be provided at the steering wheel 92.

The operating part 3a illustrated in FIG. 15 includes an air conditioner button 33a, an audio button 34a and a main controller 31a, which is formed to be rotatable and pressable and receives an instruction from a user for changing the setting related to the in-vehicle apparatus that is the displaying subject. The operating part 3a is provided in the left-hand area in the steering wheel 92.

In this case, too, the position of the air conditioner button 33a relative to the position of the main controller 31a is the right and the position of the audio button 34a relative to the position of the main controller 31a is the left. In other words, the position of the audio button 34a relative to the position of the air conditioner button 33a is the left. Further, the air conditioner button 33a may be located in the right-hand area in the steering wheel 92 while the audio button 34a may be located in the left-hand area in the steering wheel 92.

### 3-2. Addition of Button to Controller

A controller may include more buttons than those shown in FIG. 3 to improve its operational performance.

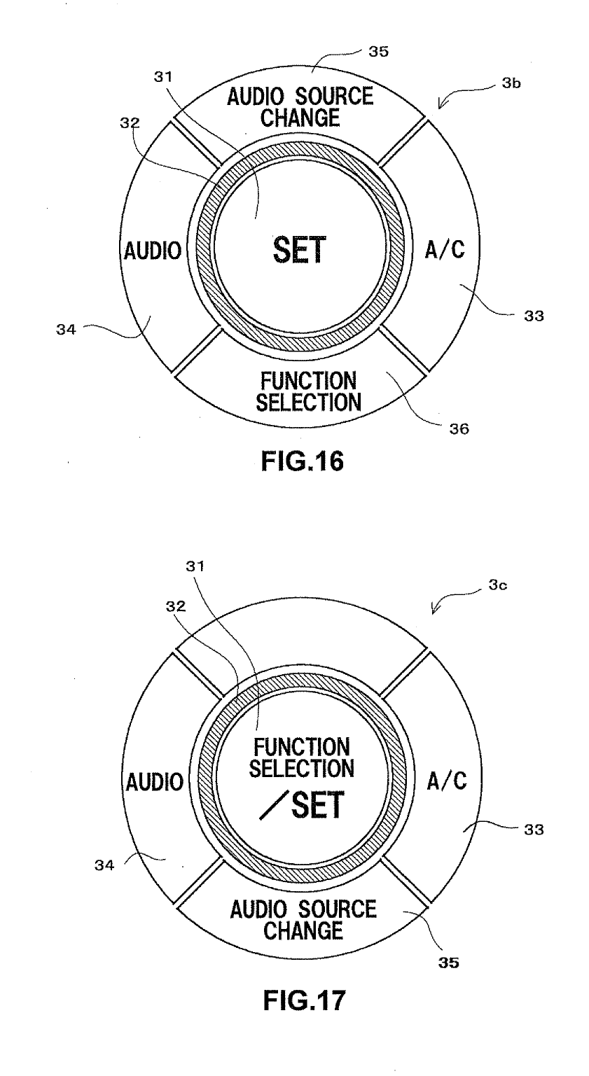

For example, an operating part 3b shown in FIG. 16 includes an audio source change button 35 and a function selection button 36 in addition to the set button 31, the rotating dial 32, the air conditioner button 33 and the audio button 34.

The source change button 35 receives an instruction from a user for moving to the status in which the source of the audio apparatus 5 can be changed. In the above embodiments, to select the status that is capable of changing source (the state S25 in FIG. 9 and the state in FIG. 14), it is necessary to move the subject item that is a subject of setting change to the source by pressing the audio button 34 several times in the audio mode M2. On the other hand, when the source change button 35 is provided, only by pressing the source change button 35, it moves directly to the status where the source can be changed immediately, in both the air conditioner mode M1 and the audio mode M2.

The function selection button 36 receives instruction from a user for changing the subject item that is a subject of the setting change. In the above embodiments, the air conditioner button 33 and the audio button 34 for receiving instruction of changing the operating mode are also used to receive instruction for changing the subject item. On the other hand, installing the function selection button 36 independently helps the user to operate it intuitively and also to prevent wrong operations such as change of the subject item by mistake when the user changes the operating mode.

Further, the function selection button 36 may be omitted like the operating part 3c shown in FIG. 17, for example. In this case, the air conditioner button 33 and the audio button 34 as well as the set button 31 may be also used to receive instruction to change the subject item like the above embodiments.

### 3-3. Other Embodiment

In the above embodiments, as the in-vehicle apparatus that displays setting information on the in-vehicle display system 10, the air conditioner apparatus 4 and the audio apparatus 5 are described. However, other type of the in-vehicle apparatus like a navigation system may be applied.

In the above embodiments, the air conditioner apparatus 4 and the audio apparatus 5 are described as the exterior components of the in-vehicle display system 10; however, the in-vehicle display system may include the in-vehicle apparatus like the air conditioner apparatus or the audio apparatus of which the setting information is displayed.

In the above embodiments, the button and the index related to the air conditioner mode M1 are located in the right-hand area while the button and the index related to the audio mode M2 are located in the left-hand area; however, the reverse position is also possible. The button and the index related to the air conditioner mode M1 may be located in one of upper and lower areas and the button and the index related the audio mode M2 may be located on the other of the upper and lower areas.

In the above embodiments, it is described that the operating mode at start up in the in-vehicle display system is the operating mode when the power was turned off last time, however, either the air conditioner mode M1 or the audio mode M2 may be designated as the operating mode at start up.

A cancel button may be provided in the operating part so that the state can return to the one before the setting change.

The above embodiments describe that the functions are implemented by a software process performed by CPU operation according to programs; however, a part of functions may be implemented using a hardware circuit.

While the invention has been shown and described in detail, the foregoing description is in all aspects illustrative and not restrictive. It is therefore understood that numerous other modifications and variations can be devised without departing from the scope of the invention.

What is claimed is:

1. An in-vehicle display system for installation in a vehicle for displaying information, the system comprising:
a display part that (i) displays multiple items of setting information respectively related to plural types of in-vehicle apparatus on a common area of a screen interchangeably such that the multiple items of one of the plural types of in-vehicle apparatus are displayed in the common area at one time, and (ii) displays an index indicating one of the in-vehicle apparatus that is presently a displaying subject of the common area;
a first switching member, provided separate from the display part, receiving an instruction from a user for switching the in-vehicle apparatus that is the displaying subject to a first apparatus of the plural types of in-vehicle apparatus; and
a second switching member, provided separate from the display part, receiving an instruction from the user for switching the in-vehicle apparatus that is the displaying subject to a second apparatus of the plural types of in-vehicle apparatus, the second apparatus being different from the first apparatus; wherein,
a position of the second switching member relative to a position of the first switching member corresponds with a displayed position of an index of the second apparatus relative to a displayed position of an index of the first apparatus.

2. The in-vehicle display system of claim 1, further comprising:
a setting change member, provided separate from the display part, receiving an instruction from the user for changing a setting related to the in-vehicle apparatus that is the displaying subject; wherein
the position of the first switching member relative to a position of the setting change member corresponds with the displayed position of the index of the first apparatus relative to a center of the common area of the screen; and
the position of the second switching member relative to the position of the setting change member corresponds with the displayed position of the index of the second apparatus relative to the center of the common area of the screen.

3. The in-vehicle display system according to claim 1, wherein
the first apparatus is an air conditioner apparatus; and
the second apparatus is an audio apparatus.

4. The in-vehicle display system according to claim 3, wherein
the first switching member is located on a driver's seat side relative to the second switching member; and
the second switching member is located on a passenger seat side relative to the first switching member.

5. The in-vehicle display system according to claim 1, wherein
the display part differentiates a background color in the common area in accordance with which of the first apparatus and the second apparatus is the in-vehicle apparatus that is presently the displaying subject.

6. The in-vehicle display system according to claim 2, further comprising:
a designating part designating one item among the multiple items of the setting information as a subject item of setting change that is to be made by the setting change member; and
a receiver that receives an instruction from the user for changing the subject item, wherein
the designating part automatically designates a predetermined item that is chosen for each of the plural types of in-vehicle apparatus as the subject item when the user does not input any instruction after a predetermined period of time.

7. An in-vehicle display system for installation in a vehicle for displaying information, the system comprising:
a display part that (i) displays multiple items of setting information respectively related to plural types of in-vehicle apparatus on a common area of a screen interchangeably such that the multiple items of one of the plural types of in-vehicle apparatus are displayed in the common area at one time, and (ii) displays an index indicating one of the in-vehicle apparatus that is presently a displaying subject of the common area;
a setting change member, provided separate from the display part, receiving an instruction from a user for changing a setting related to the in-vehicle apparatus that is the displaying subject;
a designating part designating one item among the multiple items of the setting information as a subject item of setting change that is to be made by the setting change member; and
a receiver that receives an instruction from the user for changing the subject item, wherein
the designating part automatically designates a predetermined item that is chosen for each of the plural types of in-vehicle apparatus as the subject item when the user does not input any instruction after a predetermined period of time.
